(19) United States
(12) Patent Application Publication
(10) Pub. No.: US 2024/0061803 A1
(43) Pub. Date: Feb. 22, 2024

(54) SERIALIZED BROADCAST COMMAND MESSAGING IN A DISTRIBUTED SYMMETRIC MULTIPROCESSING (SMP) SYSTEM

(71) Applicant: INTERNATIONAL BUSINESS MACHINES CORPORATION, Armonk, NY (US)

(72) Inventors: HAILEY NICHOLSON, HIGHLAND, NY (US); ROBERT J. SONNELITTER, III, BEDFORD HILLS, NY (US); EKATERINA M. AMBROLADZE, SOMERS, NY (US); DEANNA POSTLES DUNN BERGER, HYDE PARK, NY (US); VESSELINA PAPAZOVA, HIGHLAND, NY (US); GARY E. STRAIT, POUGHKEEPSIE, NY (US); CRAIG R. WALTERS, HIGHLAND, NY (US)

(21) Appl. No.: 17/888,573

(22) Filed: Aug. 16, 2022

(51) Int. Cl. G06F 15/173; G06F 13/40

(52) U.S. Cl. CPC G06F 15/17393; G06F 15/17375; G06F 13/4027

(57) ABSTRACT

Serialized broadcast command messaging in a distributed symmetric multiprocessing (SMP) system, including: sending a serial broadcast command from a home chip to a plurality of other chips comprising serial primary chip, wherein each chip of the plurality of other chips comprises a broadcast controller mapped to a home chip broadcast controller; assigning, by the serial primary chip, a tag to the serial broadcast command; sending, from the serial primary chip, to the home chip and a remainder of the plurality of other chips, the tag; and broadcasting, by the home chip and each chip of the plurality of other chips, the serial broadcast command in an order based on the tag of the serial broadcast command.

### BACKGROUND

### Field of the Invention

The field of the invention is data processing, or, more specifically, methods, apparatus, and products for serialized broadcast command messaging in a distributed symmetric multiprocessing (SMP) system.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A shows a portion of a process flow for serialized broadcast command messaging in a distributed symmetric multiprocessing (SMP) system according to some embodiments of the present disclosure.

FIG. 1B shows a portion of a process flow for serialized broadcast command messaging in a distributed symmetric multiprocessing (SMP) system according to some embodiments of the present disclosure.

FIG. 1C shows a portion of a process flow for serialized broadcast command messaging in a distributed symmetric multiprocessing (SMP) system according to some embodiments of the present disclosure.

FIG. 1D shows a portion of a process flow for serialized broadcast command messaging in a distributed symmetric multiprocessing (SMP) system according to some embodiments of the present disclosure.

FIG. 1E shows a portion of a process flow for serialized broadcast command messaging in a distributed symmetric multiprocessing (SMP) system according to some embodiments of the present disclosure.

FIG. 1F shows a portion of a process flow for serialized broadcast command messaging in a distributed symmetric multiprocessing (SMP) system according to some embodiments of the present disclosure.

FIG. 1G shows a portion of a process flow for serialized broadcast command messaging in a distributed symmetric multiprocessing (SMP) system according to some embodiments of the present disclosure.

FIG. 1H shows a portion of a process flow for serialized broadcast command messaging in a distributed symmetric multiprocessing (SMP) system according to some embodiments of the present disclosure.

FIG. 1I shows a portion of a process flow for serialized broadcast command messaging in a distributed symmetric multiprocessing (SMP) system according to some embodiments of the present disclosure.

FIG. 1J shows a portion of a process flow for serialized broadcast command messaging in a distributed symmetric multiprocessing (SMP) system according to some embodiments of the present disclosure.

FIG. 1K shows a portion of a process flow for serialized broadcast command messaging in a distributed symmetric multiprocessing (SMP) system according to some embodiments of the present disclosure.

FIG. 1L shows a portion of a process flow for serialized broadcast command messaging in a distributed symmetric multiprocessing (SMP) system according to some embodiments of the present disclosure.

FIG. 2 shows a block diagram of an example computer for serialized broadcast command messaging in a distributed symmetric multiprocessing (SMP) system according to some embodiments of the present disclosure.

FIG. 3 shows a flowchart of an example method for serialized broadcast command messaging in a distributed symmetric multiprocessing (SMP) system according to some embodiments of the present disclosure.

FIG. 4 shows a flowchart of an example method for serialized broadcast command messaging in a distributed symmetric multiprocessing (SMP) system according to some embodiments of the present disclosure.

### SUMMARY

Serialized broadcast command messaging in a distributed symmetric multiprocessing (SMP) system may include: sending a serial broadcast command from a home chip to a plurality of other chips comprising serial primary chip, wherein each chip of the plurality of other chips comprises a broadcast controller mapped to a home chip broadcast controller; assigning, by the serial primary chip, a tag to the serial broadcast command; sending, from the serial primary chip, to the home chip and a remainder of the plurality of other chips, the tag; and broadcasting, by the home chip and each chip of the plurality of other chips, the serial broadcast command in an order based on the tag of the serial broadcast command.

### DETAILED DESCRIPTION

Symmetric multiprocessing (SMP) systems use multiple processors connected to a shared main memory. In order to maintain system performance, ensure correct functional behavior and meet certain architectural requirements, commands of a certain type must go to every processor and must arrive at each processor in the same order with relation to all other commands of this same type. These commands are hereinafter referred to as “broadcast commands.” Serial broadcast commands are ordered, while non-serial broadcast commands are unordered. As an example, quiesce broadcast commands are critical to system performance in a SMP system and serialization is required to ensure proper hardware invocation of the quiesce command.

In some distributed system topologies, existing protocols for broadcast commands in SMP systems would result in broadcast command latency, which would negatively impact performance, particularly with respect to the increased overhead necessary to quiesce the system. To address these concerns, various embodiments for serialized broadcast command messaging in a distributed symmetric multiprocessing (SMP) system are set forth. These approaches improve the speed of processing serial broadcast commands by reducing the number of chip hops required to process any given serial broadcast command. Moreover, the following approaches are fast but guaranteed not to cause overflow conditions in the broadcast capture logic for the receiving chips.

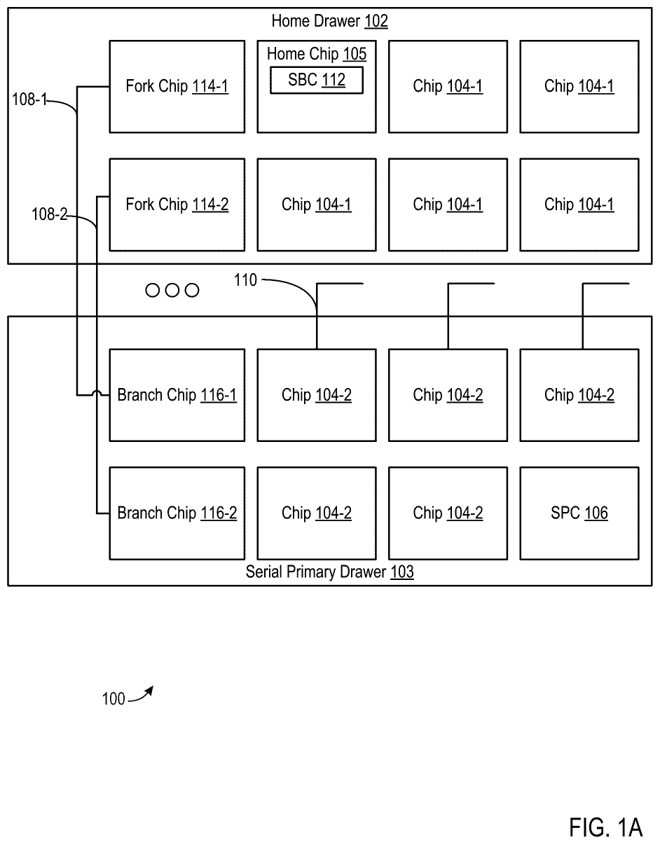

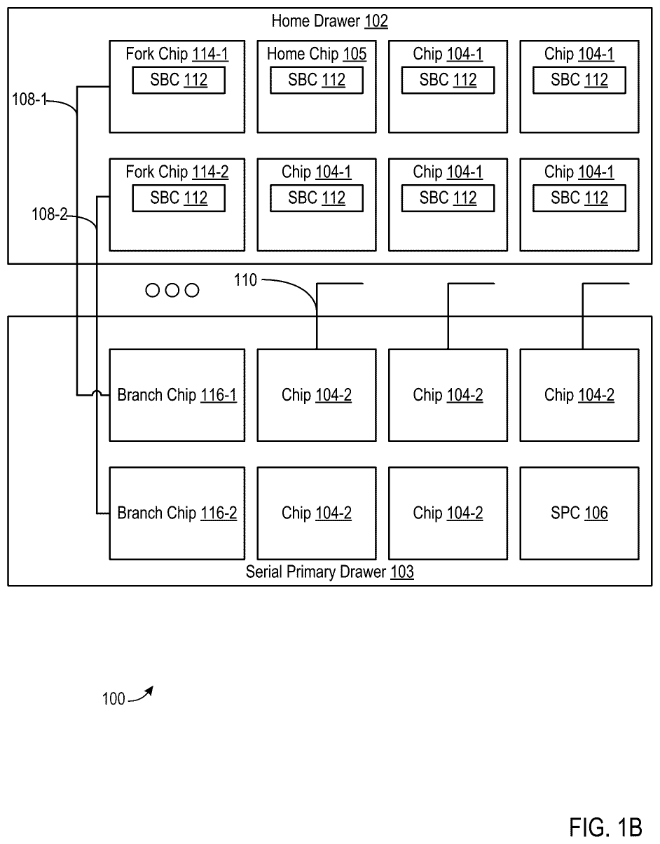

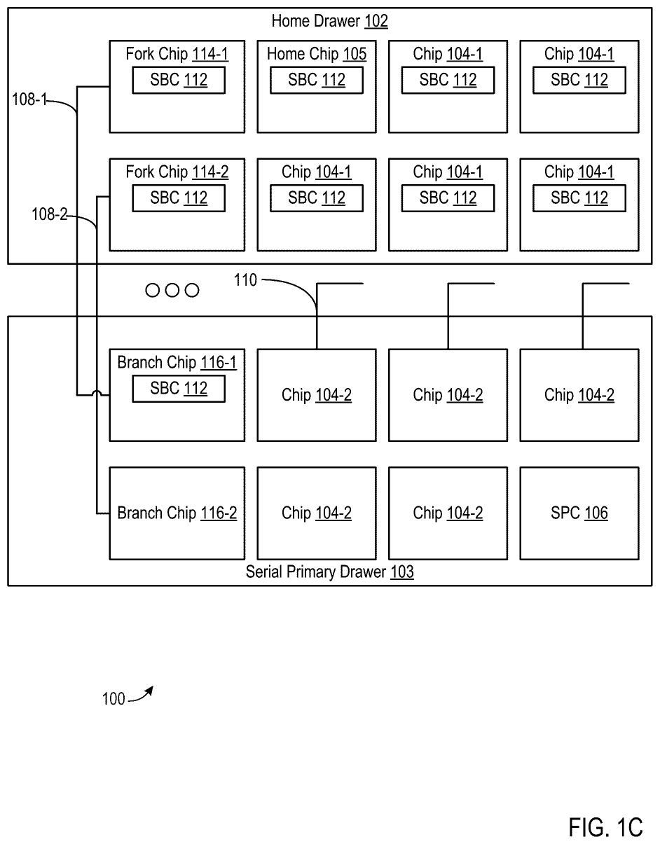

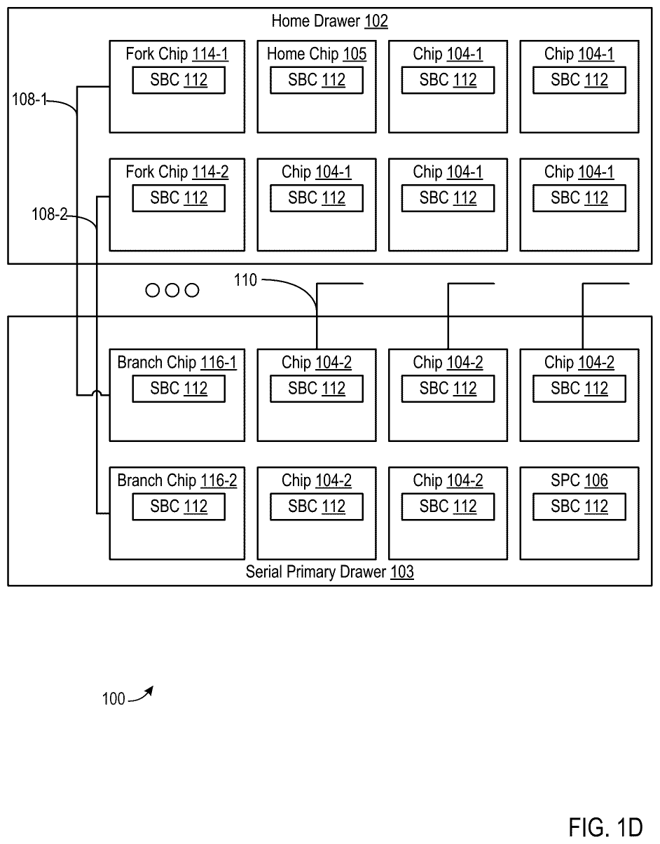

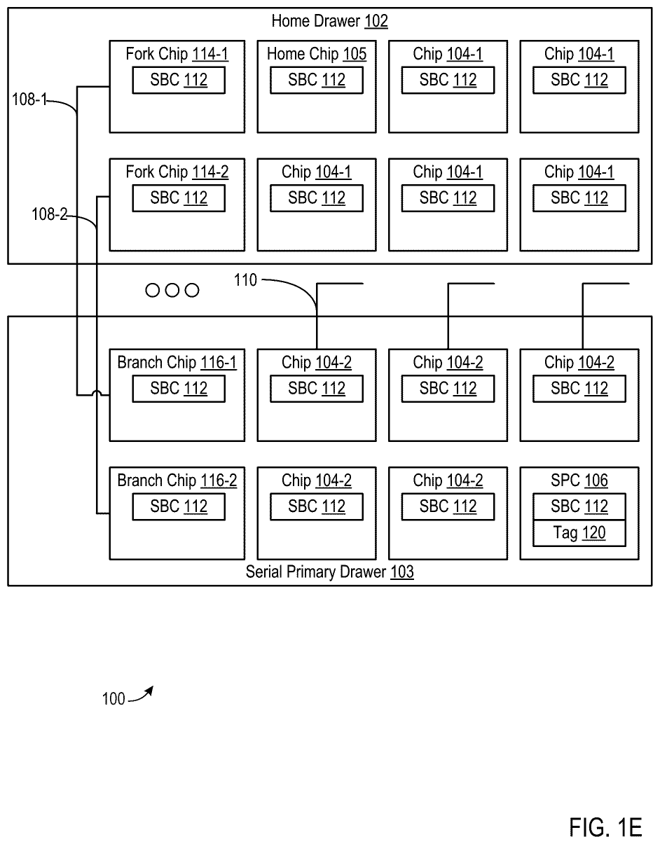

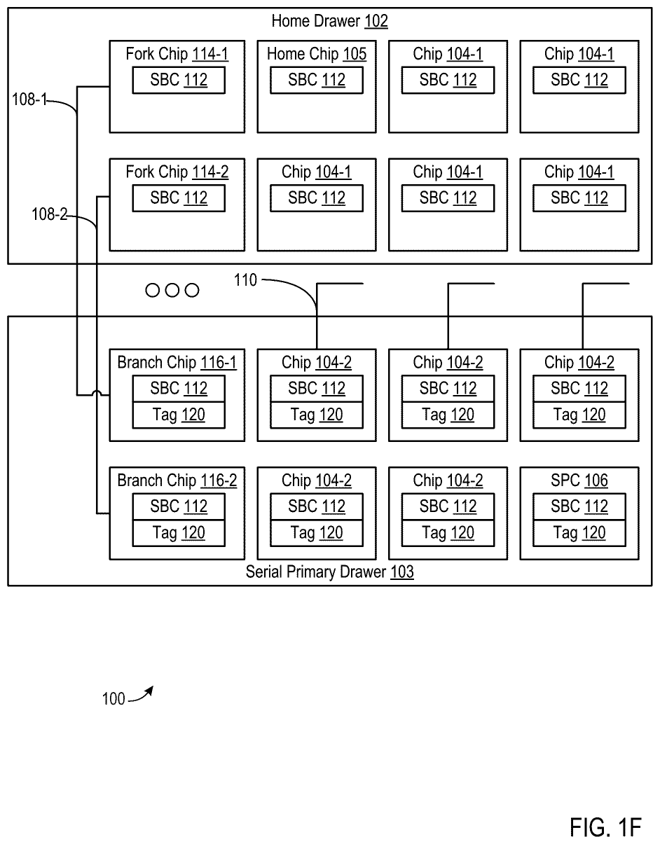

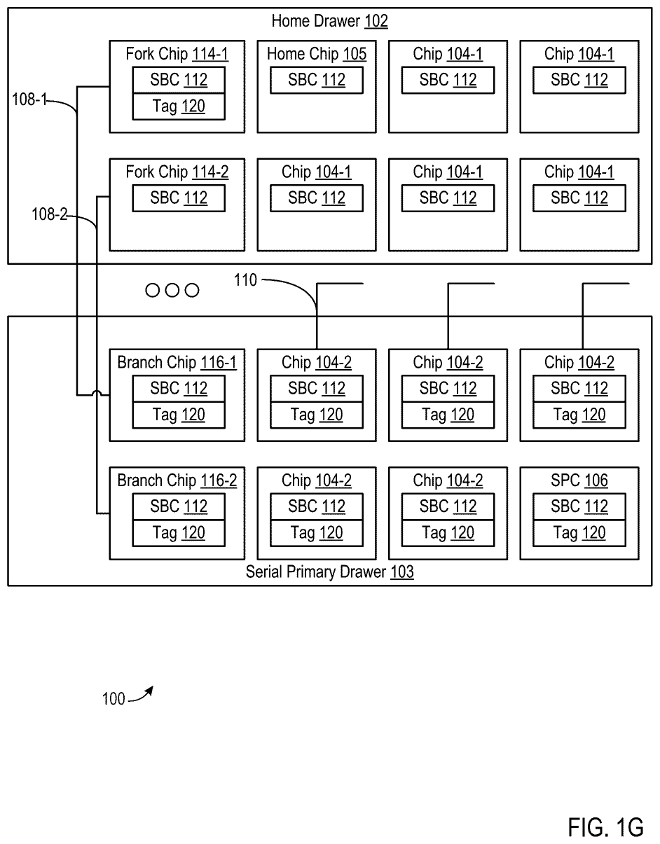

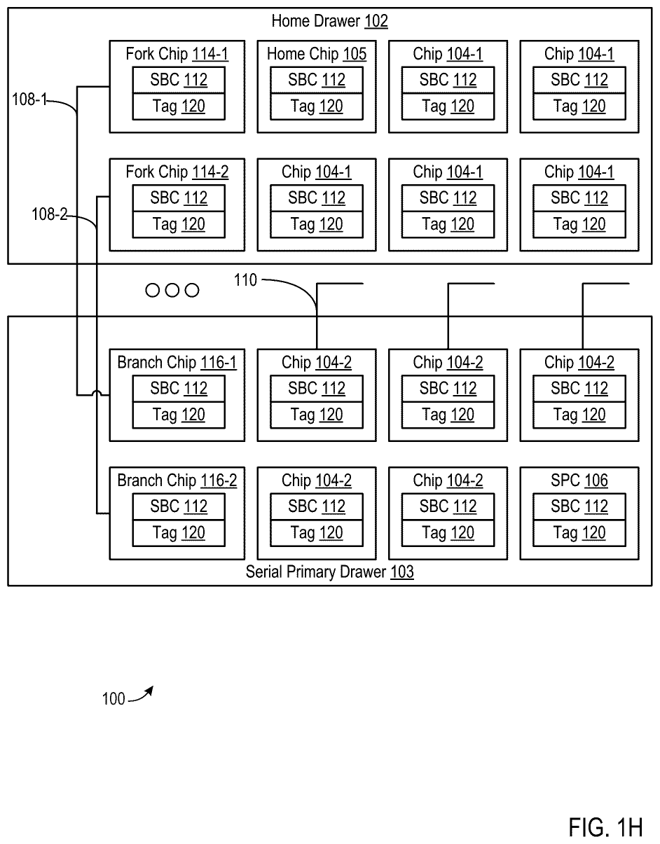

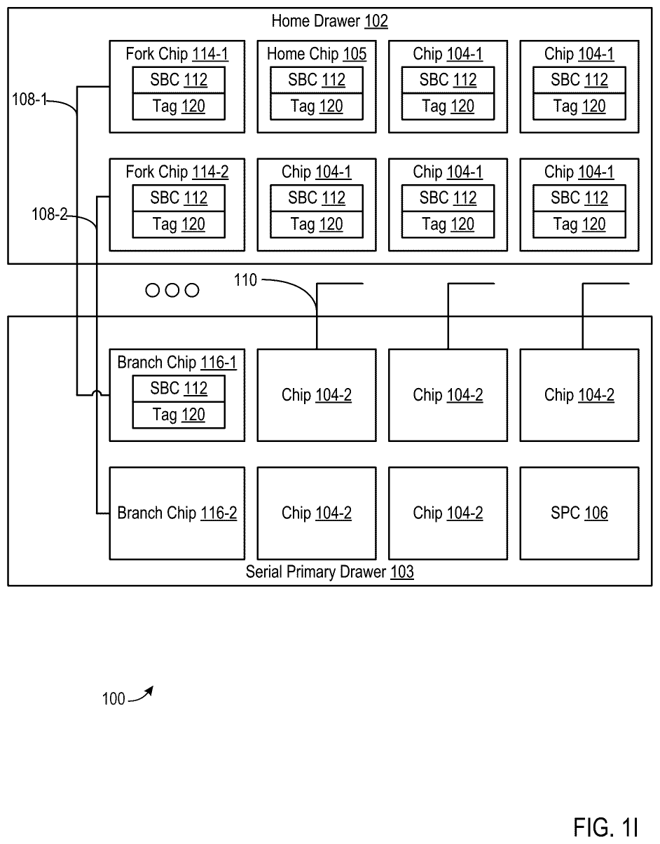

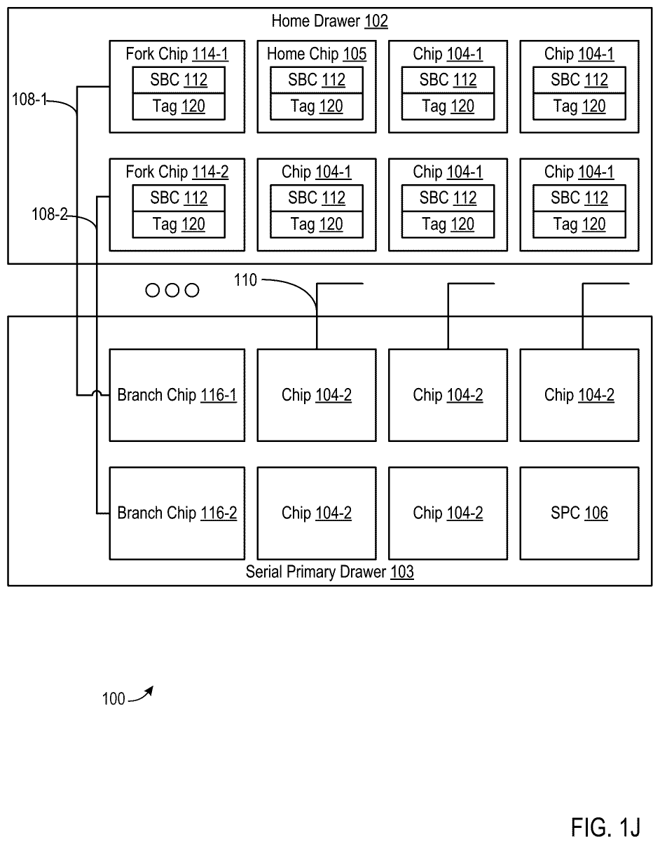

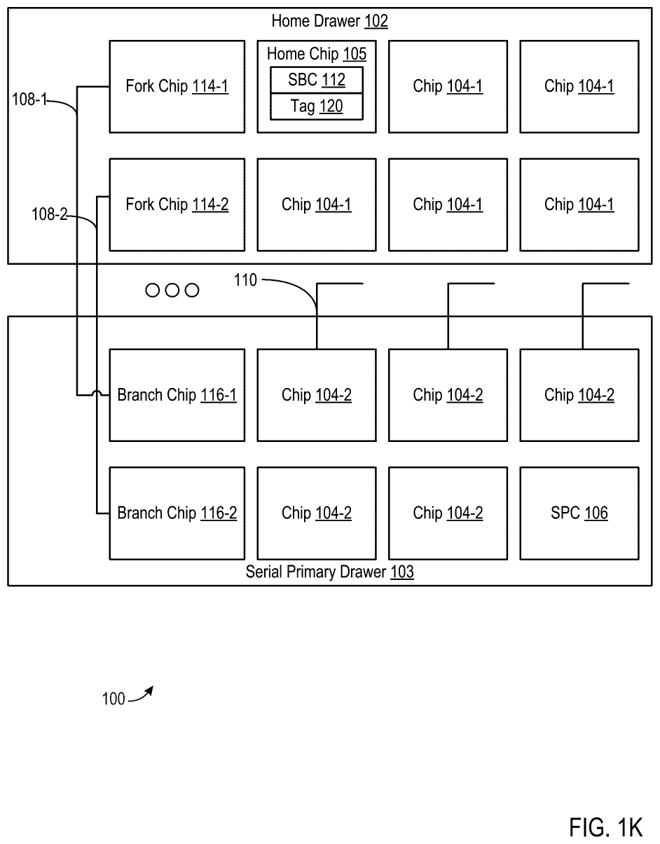

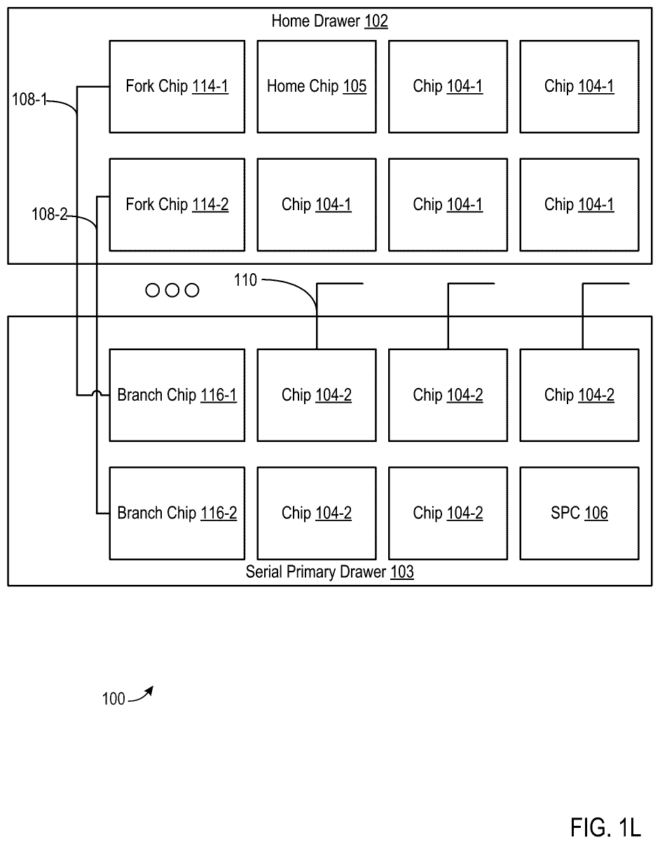

Accordingly, FIGS. 1A-1L set forth an example process flow for serialized broadcast command messaging in a distributed symmetric multiprocessing (SMP) system including an example system 100, beginning at FIG. 1A. The example system 100 includes a home drawer 102 and a serial primary drawer 103. The home drawer 102 and serial primary drawer 103 may include drawers of chips or other processing hardware in a mainframe system architecture as would be appreciated. The home drawer 102 includes home chip 105, a processor that generates a serial broadcast command (SBC) 112 for receipt by all chips in the system 100. The home drawer 102 also includes other chips 104-1 (e.g., other processors) that will receive the serial broadcast command 112, as well as fork chips 114-1,2 operatively coupled to the serial primary drawer 103 that are able to provide the serial broadcast command 112 to the serial primary drawer 103 via buses 108-1, 108-2, such as an A-bus. Each chip on the home drawer 102 (e.g., the chips 104-1, home chip 105, and fork chip 114-1,2) are operatively coupled to every other chip on the drawer via a direct bus (not shown), hereinafter referred to as an “XBUS.” The XBUS may also be coupled to off-drawer hardware that may monitor the XBUS, and accordingly receive serial broadcast commands 112, using a broadcast snoop.

The serial primary drawer 103 includes a serial primary chip (SPC) 106. As will be described in further detail below, the serial primary drawer 103 effectively serves as a serialization spot for the serial broadcast command 112, handling the assignment of tags to the serial broadcast command 112 and ensuring that the serial broadcast command 112 is executed in order. “In order” means that each processor in the system receives all serial broadcast commands in the same order that every other processor in the system receives the serial broadcast commands. The serial primary drawer 103 also includes chips 104-2 and branch chips 116-1,2. The branch chips 116-1,2 are able to receive a serial broadcast command 112 from the fork chips 114-1,2 in the home drawer 102 and provide, back to the home drawer 102, a tag from the serial primary chip 106. Each chip on the serial primary drawer 103 (e.g., the chips 104-2, serial primary chip 106, and branch chips 116-1,2) are operatively coupled via a XBUS. The XBUS may also be coupled to off-drawer hardware that may monitor the XBUS, and accordingly receive serial broadcast commands 112, using a broadcast snoop.

Although the system 100 shows only the home drawer 102 and serial primary drawer 103, one skilled in the art will appreciate that the system 100 may include one or more other drawers (not shown) consisting of any number of chips, each containing any number of processors that would also need to receive the serial broadcast command 112. Accordingly, in some embodiments, the serial primary drawer 103 also includes one or more off-drawer buses 110 (e.g., A-buses) operatively coupled to chips in other drawers. Accordingly, the chips 104-2 coupled to the off-drawer buses 110 effectively serve as fork chips 114-1,2 relative to those other drawers.

Although the following discussion describes the use of chips and drawers, the approaches set forth herein are also applicable to other configurations or topologies. For example, instead of groups of chips in drawers, the approaches set forth herein may be similarly applied to chips or processors on a same module. As another example, the approaches set forth herein may be similarly applied to cores on a same chip. Moreover, one skilled in the art will appreciate that the particular layout and configuration of the system 100 is merely exemplary and that other layouts and topologies are also contemplated within the scope of the present disclosure. One skilled in the art will appreciate that the approaches set forth herein are also applicable to configurations where the serial primary chip 106 is located on a same drawer as the home chip 105, or where the home chip 105 is also the serial primary chip 106.

As shown in FIG. 1A, the serial broadcast command 112 is generated at a home chip 105. The particular location of the home chip 105 within the home drawer 102 is dependent on which chip in the home drawer 102 is issuing a serial broadcast command. Accordingly, depending on the particular operating conditions, any chip in the home drawer 102 may serve as a home chip 105 if it needs to issue a serial broadcast command 112 to perform its function.

At FIG. 1B, the serial broadcast command 112 is sent from the home chip 105 to the other chips 104-1 and fork chips 114-2 in the home drawer 102. In some embodiments, the serial broadcast command 112 is sent via one or more direct buses (not shown for clarity). For example, the home chip 105 may be operatively coupled to the chips 104-1 and the fork chips 114-1,2 by one or more circuit switched buses (e.g., an MBUS), one or more packet switched buses (e.g., an XBUS), or combinations thereof. Accordingly, in some embodiments, the serial broadcast command 112 may be received using a bus snoop.

Each chip of the system 100 (e.g., the home chip 105, serial primary chip 106, chips 104-1,2, fork chips 114-1,2, and branch chips 116-1,2) includes a broadcast controller (not shown for clarity) for issuing or receiving broadcast commands. Each receiving chip broadcast controller is mapped to the controller of the home chip 105. Thus, the home chip 105 need not wait for permissions from other controllers, both on-drawer and off-drawer, before sending the serial broadcast command 112.

At FIG. 1C, the serial broadcast command 112 is sent from the home drawer 102 to the serial primary drawer 103. Here, the serial broadcast command 112 is sent from the fork chip 114-1 to a branch chip 116-1 via the bus 108-1. In some embodiments, the particular fork chip 114-1,2 used to send the serial broadcast command 112 to its corresponding branch chip 116-1,2 is dependent on where on the home drawer 102 the home chip 105 is located. Here, as an example, the fork chip 114-1 is used as it is located on the same half of the home drawer 102 as the home chip 105. Were the home chip 105 located on the opposing half, the fork chip 114-2 would instead be used. This reduces the number of chip hops required for the serial broadcast command 112 to get to the serial primary drawer 103.

At FIG. 1D, the serial broadcast command 112 is sent from the branch chip 116-1 to other chips on the serial primary drawer 103 (e.g., the serial primary chip 106, chips 104-2, and the branch chip 116-2. In some embodiments, the serial broadcast command 112 is sent from the branch chip 116-1 via buses (not shown for clarity). For example, the branch chip 116-1 may be operatively coupled to the chips 104-2, branch chip 116-2, and the serial primary chip 106 by one or more circuit switched buses (e.g., an MBUS), one or more packet switched buses (e.g., an XBUS), or combinations thereof. Accordingly, in some embodiments, the serial broadcast command 112 may be received using a bus snoop.

At FIG. 1E the serial primary chip 106 generates a tag 120 for the serial broadcast command 112. The tag 120 is a counter value that will be used for ensuring in-order execution of the serial broadcast command 112 as described below. For example, in some embodiments, the serial primary chip 106 sees an ingate signal that activates a controller and an attached command when any broadcast controller goes active. The serial primary chip 106 maintains a count of the next tag to grant and will send a tag to that controller some amount of cycles later (e.g., two cycles) if the command is a serial broadcast command. If the command is a non-serial broadcast command it will do nothing. The serial primary chip 106 increments a tag value each time it detects a serial broadcast pipe pass from an already-activated serial controller go around the on chip ring bus. In some embodiments, the tag 120 is generated via a serial broadcast tag controller on the serial primary chip 106.

At FIG. 1F, the serial primary chip 106 sends the tag 120 to all other chips in the serial primary drawer 103 (e.g., the chips 104-2 and branch chips 116-1,2). In some embodiments, the tag 120 is sent using a specially formatted miscellaneous response (MRESP) command. One skilled in the art will appreciate that, as each controller of the chips in the serial primary drawer 103 are already mapped to the home chip 105 controller, these chips can receive the tag 120 before actually receiving the serial broadcast command 112, which may occur depending on the timing and latencies associated with propagating the serial broadcast command 112 and the physical relationship between the SBC and the other chips. If the broadcast controller receives the tag before the command, the controller captures the tag from the MRESP, activates its state machine and monitors for serial broadcast commands arrival. As these chips can receive the tag 120 before actually receiving the serial broadcast command 112, this speeds the overall process described herein.

At FIG. 1G, the tag 120 is sent from the branch chip 116-1 to the fork chip 114-1 via the bus 108-1 (e.g., via MRESP). Where the system 100 includes other drawers, the tag 120 and serial broadcast command 112 would be sent to the other drawers via off-drawer buses 110 (e.g., via MRESP). At FIG. 1H, the tag is sent from the fork chip 114-1 to the fork chip 114-2, home chip 105, and chips 104-1. At this point, all chips have the serial broadcast command 112 and tag 120 for the serial broadcast command 112.

Each chip now waits for a local tag to match the tag 120 for the serial broadcast command 112. Each chip has a local tag value that begins at some initialized value (e.g., zero) that is incremented every time a serial broadcast pipe pass from an activated controller goes on an on-chip ring bus. When the local tag is equal to the tag 120 for the serial broadcast command 112, the given chip can send a broadcast snoop along the on-chip ring bus to send the serial broadcast command 112 to broadcast receiver hardware in the processor core, utilizing a special identification flag on the ring pass to alert the processor hardware that the broadcast is targeting the processors. In some embodiments, the on-chip ring includes two address bit selected slices, with each slice time-separated into two pipes based on a different address bit. The ring bus outbound logic then drives pipe based versions of the ring messages to certain clients which require the extra bandwidth provided by the dual pipes. For physical design optimization, the ring station that routes messages to the processor cores are only connected on one of the pipes (pipe 0). Because only one ring pass is necessary to forward the broadcast to the core, in some embodiments multiple ring passes may be necessary within the nest to achieve the serialization. Therefore for bandwidth purposes to maximize performance within the nest, it is desirable that both broadcast controllers are utilized on both pipes. Therefore, when the tag match allows the broadcast state machines to send the serial broadcast to the broadcast receive logic in the processor core, special logic in the ring onboarding path ensures that both pipe 0 broadcast controllers and pipe 1 broadcast controllers all enter the ring with pipe 0 timing. The respective chip local tags may equal the tag 120 for the serial broadcast command 112, and accordingly issue a broadcast snoop around the on chip ring bus to the receiving hardware in the processor cores, in any order in relation to the time the broadcast commands were issued by the processor on the home chip, but ensures that they all receiving cores receive all serial broadcast commands in the same order across the system

At FIG. 1I, after issuing the serial broadcast command 112 via the on-chip ring bus to the core hardware, the serial primary chip 106, chips 104-2, and branch chip 116-2 send a resource response (RRESP) to the branch chip 116-1 and drop the broadcast controller valid. Any other drawers also send such responses to the branch chip 116-1 via the off-chip buses 110. At FIG. 1J the branch chip 116-1 sends a response to the fork chip 114-1 and drops the broadcast controller valid. At FIG. 1K, the fork chips 114-1,2 and chips 104-1 send responses to the home chip 105 and drop the broadcast controller valid. At FIG. 1L, the home chip 105 sends a response over the on-chip ring bus and drops the home chip broadcast controller valid. A final SRESP message is sent to the hardware in the processor that launched the serial broadcast command on the home chip. The serial broadcast command 112 is now complete.

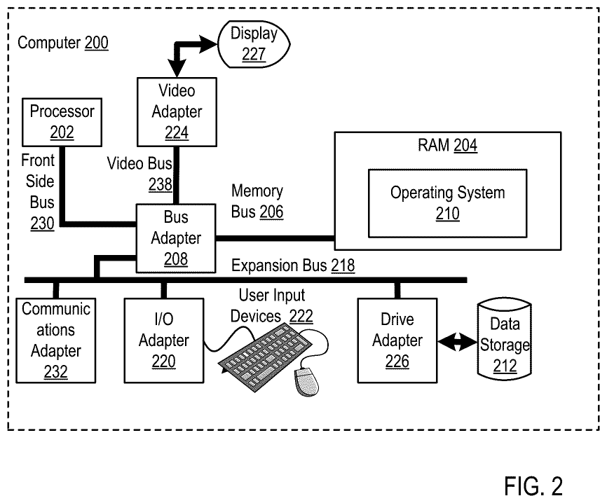

Serialized broadcast command messaging in a distributed symmetric multiprocessing (SMP) system in accordance with the present application is generally implemented with computers, that is, with automated computing machinery. For further explanation, therefore, FIG. 2 sets forth a block diagram of computing machinery including an exemplary computer 200 configured for serialized broadcast command messaging in a distributed symmetric multiprocessing (SMP) system according to certain embodiments. The computer 200 of FIG. 2 includes at least one computer processor 202 or ‘CPU’ as well as RAM 204 (‘Random Access Memory’) which is connected through a high speed memory bus 206 and bus adapter 208 to processor 202 and to other components of the computer 200.

Stored in RAM 204 is an operating system 210. Operating systems useful in computers configured for serialized broadcast command messaging in a distributed symmetric multiprocessing (SMP) system according to certain embodiments include UNIX™, Linux™, Microsoft Windows™, and others as will occur to those of skill in the art. The operating system 210 in the example of FIG. 2 is shown in RAM 204, but many components of such software typically are stored in non-volatile memory also, such as, for example, on data storage 212, such as a disk drive.

The computer 200 of FIG. 2 includes disk drive adapter 226 coupled through expansion bus 218 and bus adapter 208 to processor 202 and other components of the computer 200. Disk drive adapter 226 connects non-volatile data storage to the computer 200 in the form of data storage 212. Disk drive adapters useful in computers configured for serialized broadcast command messaging in a distributed symmetric multiprocessing (SMP) system according to certain embodiments include Integrated Drive Electronics (‘IDE’) adapters, Small Computer System Interface (‘SCSI’) adapters, and others as will occur to those of skill in the art. In some embodiments, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 200 of FIG. 2 includes one or more input/output (‘I/O’) adapters 220. I/O adapters implement user-oriented input/output through, for example, software drivers and computer hardware for controlling output to display devices such as computer display screens, as well as user input from user input devices 222 such as keyboards and mice. The example computer 200 of FIG. 2 includes a video adapter 224, which is an example of an I/O adapter specially designed for graphic output to a display device 227 such as a display screen or computer monitor. Video adapter 224 is connected to processor 202 through a high speed video bus 238, bus adapter 208, and the front side bus 230, which is also a high speed bus.

The exemplary computer 200 of FIG. 2 includes a communications adapter 232 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters implement the hardware level of data communications through which one computer sends data communications to another computer, directly or through a data communications network. Examples of communications adapters useful in computers configured for serialized broadcast command messaging in a distributed symmetric multiprocessing (SMP) system according to certain embodiments include modems for wired dial-up communications, Ethernet (IEEE 802.3) adapters for wired data communications, and 802.11 adapters for wireless data communications.

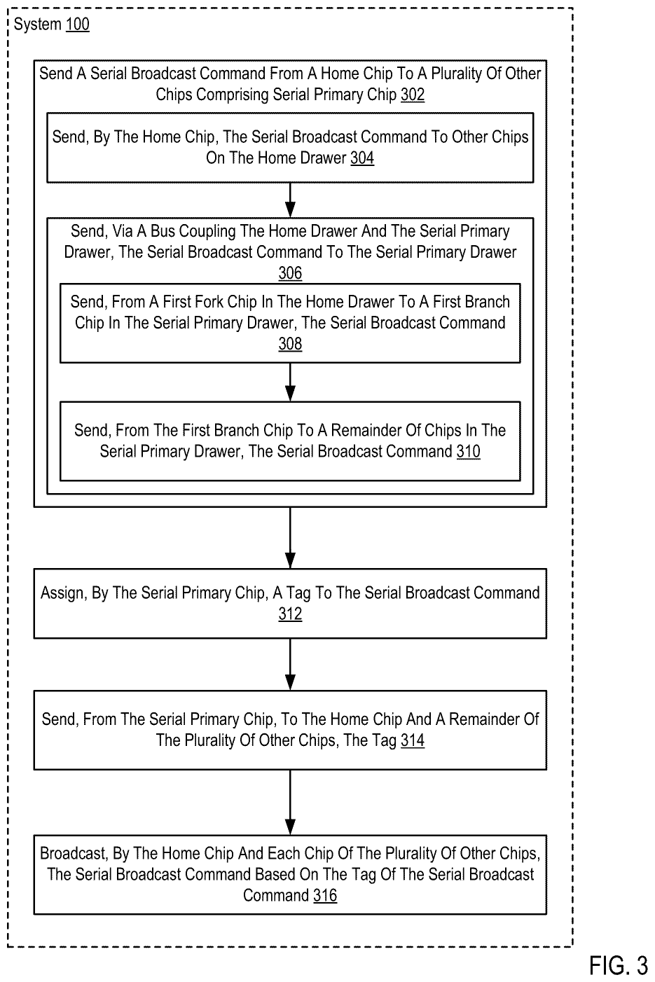

For further explanation, FIG. 3 shows a flowchart of an example method for serialized broadcast command messaging in a distributed symmetric multiprocessing (SMP) system according to some embodiments of the present disclosure. The method of FIG. 3 may be performed, for example, by a system 100 as set forth in FIGS. 1A-1L. The method of FIG. 3 includes sending 302 a serial broadcast command 112 from a home chip 105 to a plurality of other chips including a serial primary chip 106. Such other chips may include other chips on a home drawer 102 (e.g., fork chips 114-1,2, chips 104-1), chips on a serial primary drawer 103 (e.g., branch chips 116-1,2, chips 104-2), and potentially chips on other drawers operatively coupled to the serial primary drawer 103 via off-chip buses 110.

In some embodiments, sending 302 a serial broadcast command 112 from a home chip 105 to a plurality of other chips including a serial primary chip 106 includes sending 304, by the home chip 105, the serial broadcast command to other chips on the home drawer 102 (e.g., fork chips 114-1,2, chips 104-1). Sending 304 the serial broadcast command to other chips on the home drawer 102 may be performed via direct buses directly coupling each chip. For example, the home chip 105 may be operatively coupled to the chips 104-1 and the fork chips 114-1,2 by one or more circuit switched buses (e.g., an MBUS), one or more packet switched buses (e.g., an XBUS), or combinations thereof. Accordingly, in some embodiments, the serial broadcast command 112 may be received using a bus snoop

In some embodiments, sending 302 a serial broadcast command 112 from a home chip 105 to a plurality of other chips including a serial primary chip 106 also includes sending 306, via a bus 108-1 coupling the home drawer 102 to the serial primary drawer 103, the serial broadcast command 112 to the serial primary drawer 103. For example, sending 306 the serial broadcast command 112 to the serial primary drawer 103 may include sending 308, from a first fork chip 114-1 in the home drawer 102 to a first branch chip 116-1 in the serial primary drawer 103, the serial broadcast command 112. For example, the serial broadcast command 112 may be sent via a bus coupling the first branch chip 116-1 to the first fork chip 114-1. Sending 306 the serial broadcast command 112 to the serial primary drawer 103 may also include sending 310, from the first branch chip 116-1 to a remainder of chips in the serial primary drawer 103 (e.g., a second branch chip 116-2, chips 104-2, the serial primary chip 106), the serial broadcast command 112.

The method of FIG. 3 also includes assigning 312, by the serial primary chip 106, a tag 120 to the serial broadcast command 112. The tag 120 is a counter value that will be used for ensuring in-order execution of the serial broadcast command 112 as described below. For example, in some embodiments, the serial primary chip 106 sees an ingate signal that activates a controller and an attached command when any broadcast controller goes active. The serial primary chip 106 maintains a count of the next tag to grant and will send a tag to that controller some amount of cycles later (e.g., two cycles) if the command is a serial broadcast command. If the command is a non-serial broadcast command it will do nothing. The serial primary chip 106 increments a tag value each time it detects a serial broadcast pipe pass from an already-activated serial controller go around the on-chip ring bus. In some embodiments, the tag 120 is generated via a serial broadcast tag controller on the serial primary chip 106.

The method of FIG. 3 also includes sending 314, from the serial primary chip 106, to the home chip 105 and a remainder of the plurality of other chips (e.g., the fork chips 114-1,2, branch chips 116-1,2, chips 104-1,2), the tag 120. For example, the serial primary chip 106 may send the tag 120 to other chips on the serial primary drawer 103 including the branch chips 116-1,2 and chips 104-2. The branch chip 116-1 may then send the tag 120 to the fork chip 114-1, which in turn sends the tag 120 to the home chip 105, chips 104-1, and fork chip 114-2.

The method of FIG. 3 also includes broadcasting 316, by the home chip 105 and each chip of the plurality of other chips, the serial broadcast command 112 based on the tag 120 of the serial broadcast command 112. Each chip has a local tag value that begins at some initialized value (e.g., zero) that is incremented every time a serial broadcast pipe pass from an activated controller goes on an on-chip ring bus. When the local tag is equal to the tag 120 for the serial broadcast command 112, the given chip can send a broadcast snoop along the on-chip ring bus to send the serial broadcast command 112 to receiving hardware. In some embodiments, the on-chip ring includes two address bit selected slices and further time-separated into two pipes based on a different address bit. The ring bus outbound logic then drives pipe based versions of the ring messages to certain clients which require the bandwidth. For physical design optimization, the ring station that routes messages to the processor cores are only connected on one of the pipes (pipe 0) even though for bandwidth purposes both broadcast controllers are utilized on both pipes. Therefor when the tag match allows the broadcast state machines to send the serial broadcast to the broadcast receive logic in the processor core, special logic in the ring onboarding path ensures that both pipe 0 broadcast controllers and pipe 1 broadcast controllers all enter the ring with pipe 0 timing. The respective chip local tags may equal the tag 120 for the serial broadcast command 112, and accordingly issue a broadcast snoop around the on chip ring to the receiving hardware in the processor cores, in any order in relation to the time the broadcast commands were issued by the processor on the home chip, but ensures that they all receiving cores receive all serial broadcast commands in the same order across the system.

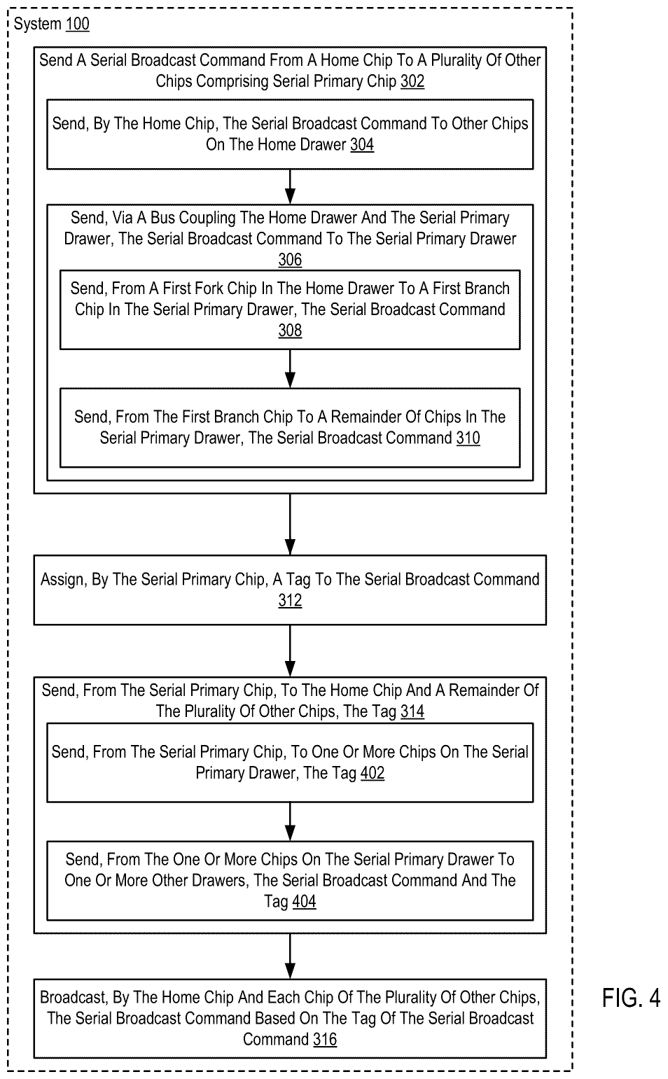

For further explanation, FIG. 4 sets forth a flowchart of another example method for serialized broadcast command messaging in a distributed symmetric multiprocessing (SMP) system according to some embodiments of the present disclosure. The method of FIG. 4 is similar to FIG. 3 in that the method of FIG. 4, differing in that sending 314, from the serial primary chip 106, to the home chip 105 and a remainder of the plurality of other chips, the tag 120 includes: sending 402, from the serial primary chip 106, to one or more chips 104-2 on the serial primary drawer 103, the tag 120. The one or more chips 104-2 are coupled to one or more other drawers via one or more off-chip buses 110. Accordingly, the one or more other chips 104-2 effectively serve as fork chips relative to the other drawers.

FIG. 4 also includes sending 404, from the one or more chips 104-2 on the serial primary drawer 103 to one or more other drawers, the serial broadcast command 112 and the tag 120 (e.g., via the one or more off-chip buses 110). Thus, each off-drawer chip now has the tag 120 and corresponding serial broadcast command.

Exemplary embodiments of the present invention are described largely in the context of a fully functional computer system for serialized broadcast command messaging in a distributed symmetric multiprocessing (SMP) system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of serialized broadcast command messaging in a distributed symmetric multiprocessing (SMP) system, the method comprising:
sending a serial broadcast command from a home chip to a plurality of other chips comprising serial primary chip, wherein each chip of the plurality of other chips comprises a broadcast controller mapped to a home chip broadcast controller;
assigning, by the serial primary chip, a tag to the serial broadcast command;
sending, from the serial primary chip, to the home chip and a remainder of the plurality of other chips, the tag; and
broadcasting, by the home chip and each chip of the plurality of other chips, the serial broadcast command in an order based on the tag of the serial broadcast command.

2. The method of claim 1, wherein the home chip is included in a home drawer and the serial primary chip is included in a serial primary drawer.

3. The method of claim 2, wherein sending the serial broadcast command from the home chip to the plurality of other chips comprises:
sending, by the home chip, the serial broadcast command to other chips on the home drawer; and
sending, via a bus coupling the home drawer and the serial primary drawer, the serial broadcast command to the serial primary drawer.

4. The method of claim 3, wherein sending the serial broadcast command to the serial primary drawer comprises:
sending, from a first fork chip in the home drawer to a first branch chip in the serial primary drawer, the serial broadcast command; and
sending, from the first branch chip to a remainder of chips in the serial primary drawer, the serial broadcast command.

5. The method of claim 4, wherein the bus is a first bus of a pair of buses coupling the home drawer to the serial primary drawer.

6. The method of claim 5, wherein the pair of buses further comprises a second bus coupling a second fork chip in the home drawer to a second branch chip in the serial primary drawer.

7. The method of claim 5, wherein sending the tag comprises:
sending, from the serial primary chip, to one or more chips on the serial primary drawer, the tag; and
sending, from the one or more chips on the serial primary drawer to one or more other drawers, the serial broadcast command and the tag.

8. The method of claim 7, wherein each of the one or more chips of the serial primary drawer is coupled to a corresponding drawer of the one or more other drawers.

9. The method of claim 1, wherein the serial broadcast command is broadcast by the home chip and the plurality of other chips responsive to a respective local tag matching the tag of the serial broadcast command.

10. The method of claim 9, wherein the serial broadcast command is broadcast via an on-chip ring.

11. A system for serialized broadcast command messaging in a distributed symmetric multiprocessing (SMP) system, comprising:
a home chip;
a plurality of other chips comprising a serial primary chip, wherein each chip of the plurality of other chips comprises a broadcast controller mapped to a home chip broadcast controller; and
wherein the system is configured to perform steps comprising:
sending a serial broadcast command from the home chip to the plurality of other chips;
assigning, by the serial primary chip, a tag to the serial broadcast command;
sending, from the serial primary chip, to the home chip and a remainder of the plurality of other chips, the tag; and
broadcasting, by the home chip and each chip of the plurality of other chips, the serial broadcast command based on the tag of the serial broadcast command.

12. The system of claim 11, wherein the home chip is included in a home drawer and the serial primary chip is included in a serial primary drawer.

13. The system of claim 12, wherein sending the serial broadcast command from the home chip to the plurality of other chips comprises:
sending, by the home chip, the serial broadcast command to other chips on the home drawer; and
sending, via a bus coupling the home drawer and the serial primary drawer, the serial broadcast command to the serial primary drawer.

14. The system of claim 13, wherein sending the serial broadcast command to the serial primary drawer comprises:
sending, from a first fork chip in the home drawer to a first branch chip in the serial primary drawer, the serial broadcast command; and
sending, from the first branch chip to a remainder of chips in the serial primary drawer, the serial broadcast command.

15. The system of claim 14, wherein the bus is a first bus of a pair of buses coupling the home drawer to the serial primary drawer.

16. The system of claim 15, wherein the pair of buses further comprises a second bus coupling a second fork chip in the home drawer to a second branch chip in the serial primary drawer.

17. The system of claim 15, wherein sending the tag comprises:
sending, from the serial primary chip, to one or more chips on the serial primary drawer, the tag; and
sending, from the one or more chips on the serial primary drawer to one or more other drawers, the serial broadcast command and the tag.

18. The system of claim 17, wherein each of the one or more chips of the serial primary drawer is coupled to a corresponding drawer of the one or more other drawers.

19. The system of claim 11, wherein the serial broadcast command is broadcast by the home chip and the plurality of other chips responsive to a respective local tag matching the tag of the serial broadcast command.

20. The system of claim 19, wherein the serial broadcast command is broadcast by via an on-chip ring.
